(19) United States
(12) Patent Application Publication
(10) Pub. No.: US 2025/0385338 A1
(43) Pub. Date: Dec. 18, 2025

(54) BATTERY CELL WITH A THERMAL RUNAWAY PROPAGATION MANAGEMENT SYSTEM AND METHOD OF MANUFACTURING SAME

(71) Applicant: GM Global Technology Operations LLC, Detroit, MI (US)

(72) Inventors: Ryan Patrick Hickey, Austin, TX (US); Taylor Reed Garrick, Bloomfield Hills, MI (US); Karl Chanler Dorgan, West Bloomfield, MI (US)

(73) Assignee: GM Global Technology Operations LLC, Detroit, MI (US)

(21) Appl. No.: 18/744,614

(22) Filed: Jun. 15, 2024

(51) Int. Cl. H01M 10/6569; H01M 10/625; H01M 10/647; H01M 10/653; H01M 10/655; H01M 50/691

(52) U.S. Cl. CPC H01M 10/6569; H01M 10/647; H01M 10/653; H01M 10/655; H01M 50/691; H01M 10/625

(57) ABSTRACT

A prismatic battery cell comprising a prismatic can defining a chamber, a first terminal and a second terminal each coupled to the prismatic can, a vent coupled to the prismatic can and in fluid communication with the chamber, and battery internals arranged in the chamber comprising at least one jelly roll. The prismatic battery cell further comprising a thermal runaway propagation management system comprising a bladder arranged in the chamber with respect to the at least one jelly roll, a port coupled to the prismatic can and in fluid communication with the bladder, and a fluid at least partially filling the bladder.

### INTRODUCTION

The information provided in this section is for the purpose of generally presenting the context of the disclosure. Work of the presently named inventors, to the extent it is described in this section, as well as aspects of the description that may not otherwise qualify as prior art at the time of filing, are neither expressly nor impliedly admitted as prior art against the present disclosure.

The present disclosure relates generally to a battery cell and, more particularly, to a thermal runaway propagation management system of a battery cell and method of manufacturing the same.

In general, electric vehicles can be equipped with a battery pack that includes one or more battery cells. Lithium-ion batteries are typically used in vehicles due to their high energy and power densities. Sometimes, however, a chain of uncontrolled exothermic reactions can occur within the lithium-ion batteries (i.e., thermal runaway). These reactions can result in a rise in internal temperature of the battery that causes inner structures of the battery to destabilize and degrade and eventually lead to failure of the battery. Some batteries or battery packs include thermal runaway propagation management (TRP) systems, but they either take up a large amount of space or are ineffective during a thermal runaway scenario. Shortcomings of existing systems and methods are addressed by one or more aspects of the present disclosure.

### SUMMARY

According to one configuration, a prismatic battery cell is provided and includes a prismatic can defining a chamber, a first terminal and a second terminal each coupled to the prismatic can, a vent coupled to prismatic can and in fluid communication with the chamber, and battery internals arranged in the chamber including at least one jelly roll. The prismatic battery cell further including a thermal runaway propagation management system including a bladder arranged in the chamber with respect to the at least one jelly roll, a port coupled to the prismatic can and in fluid communication with the bladder, and a fluid at least partially filling the bladder.

The prismatic battery cell may include one or more of the following optional aspects. For example, the prismatic can may include a first end and a second end opposite the first end. The chamber can further include a thermal conductive pathway at the second end for removing heat from the prismatic battery cell. The bladder can extend between the first end and the second end and contact the thermal conductive pathway.

According to at least one aspect, the bladder can define a bladder volume and the fluid can consume about half of the bladder volume during normal operation of the prismatic battery cell.

According to another aspect, the bladder can define a bladder volume and the fluid can consume about all of the bladder volume during cell assembly.

According to at least one example, the fluid can have a low boiling point. The fluid can be a sodium bicarbonate slurry.

According to another example, the bladder can be made of an aluminum alloy.

According to at least one aspect, the bladder can be made of polyethylene terephthalate.

According to another aspect, the at least one jelly roll can include a first jelly roll and a second jelly roll, the bladder being sandwiched between the first jelly roll and the second jelly roll.

According to at least one example, the at least one jelly roll can be wound around the bladder.

According to another configuration a vehicle is provided and includes a vehicle body, a battery pack including one or more battery modules and coupled to the vehicle body, and one or more prismatic battery cells arranged in the one or more battery modules. The one or more prismatic battery cells includes a prismatic can defining a chamber, a first terminal and a second terminal each coupled to the prismatic can, a vent coupled to the prismatic can in fluid communication with the chamber, and battery internals arranged in the chamber including at least one jelly roll. The one or more prismatic battery cells further including a thermal runaway propagation management system including a bladder defining a bladder volume and arranged in the chamber with respect to the at least one jelly roll, a port coupled to the prismatic can and in fluid communication with the bladder, and a fluid including a low boiling point at least partially filling the bladder during normal cell operation.

The vehicle may include one or more of the following optional aspects. For example, the chamber can further include a thermal conductive pathway for removing heat from the prismatic can.

According to at least one aspect, the fluid can be a sodium bicarbonate slurry.

According to another aspect, the bladder can be made of an aluminum alloy.

According to at least one example, the bladder can be made of polyethylene terephthalate.

According to another example, the at least one jelly roll can include a first jelly roll and a second jelly roll spaced from the first jelly roll.

According to at least one aspect, the at least one jelly roll can be wound around the bladder.

According to another configuration, a method of manufacturing a prismatic battery cell is provided. The method includes arranging one or more jelly rolls in a prismatic can, arranging a bladder in the prismatic can with respect to the one or more jelly rolls, filling the bladder with a fluid via a fill port, pressurizing the bladder so that the bladder exerts a bladder force on the one or more jelly rolls and the prismatic can, applying a mechanical force on the prismatic can opposite the bladder force, completing a formation procedure for developing one or more protective layers on electrodes of the one or more jelly rolls, removing at least some of the fluid from the bladder via the fill port, and sealing the bladder so that the bladder is configured to operate as a thermal runaway propagation management system.

### BRIEF DESCRIPTION OF THE DRAWINGS

The drawings described herein are for illustrative purposes only of selected configurations and are not intended to limit the scope of the present disclosure.

FIG. 1 is a perspective view of a vehicle including a battery pack according to principles of the present disclosure;

FIG. 2 is a perspective of a battery cell of the battery pack of FIG. 1 according to the principles of the present disclosure;

FIG. 3 is a top view of the battery cell of FIG. 2;

FIG. 4 is a cross-sectional view of the battery of FIG. 2 along line 4-4 according to a first configuration;

FIG. 5 is a cross-sectional view of the battery of FIG. 2 along line 4-4 according to a second configuration;

FIG. 6 is a cross-sectional view of the battery of FIG. 2 along line 5-5 according to the first configuration; and

FIG. 7 is a flow diagram of a method of manufacturing the battery cell of FIG. 2 according to principles of the present disclosure.

Corresponding reference numerals indicate corresponding parts throughout the drawings.

### DETAILED DESCRIPTION

Example configurations will now be described more fully with reference to the accompanying drawings. Example configurations are provided so that this disclosure will be thorough, and will fully convey the scope of the disclosure to those of ordinary skill in the art. Specific details are set forth such as examples of specific components, devices, and methods, to provide a thorough understanding of configurations of the present disclosure. It will be apparent to those of ordinary skill in the art that specific details need not be employed, that example configurations may be embodied in many different forms, and that the specific details and the example configurations should not be construed to limit the scope of the disclosure.

The terminology used herein is for the purpose of describing particular exemplary configurations only and is not intended to be limiting. As used herein, the singular articles “a,” “an,” and “the” may be intended to include the plural forms as well, unless the context clearly indicates otherwise. The terms “comprises,” “comprising,” “including,” and “having,” are inclusive and therefore specify the presence of features, steps, operations, elements, and/or components, but do not preclude the presence or addition of one or more other features, steps, operations, elements, components, and/or groups thereof. The method steps, processes, and operations described herein are not to be construed as necessarily requiring their performance in the particular order discussed or illustrated, unless specifically identified as an order of performance. Additional or alternative steps may be employed.

When an element or layer is referred to as being “on,” “engaged to,” “connected to,” “attached to,” or “coupled to” another element or layer, it may be directly on, engaged, connected, attached, or coupled to the other element or layer, or intervening elements or layers may be present. In contrast, when an element is referred to as being “directly on,” “directly engaged to,” “directly connected to,” “directly attached to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

The terms “first,” “second,” “third,” etc. may be used herein to describe various elements, components, regions, layers and/or sections. These elements, components, regions, layers and/or sections should not be limited by these terms. These terms may be only used to distinguish one element, component, region, layer or section from another region, layer or section. Terms such as “first,” “second,” and other numerical terms do not imply a sequence or order unless clearly indicated by the context. Thus, a first element, component, region, layer or section discussed below could be termed a second element, component, region, layer or section without departing from the teachings of the example configurations.

In this application, including the definitions below, the term “module” may be replaced with the term “circuit.” The term “module” may refer to, be part of, or include an Application Specific Integrated Circuit (ASIC); a digital, analog, or mixed analog/digital discrete circuit; a digital, analog, or mixed analog/digital integrated circuit; a combinational logic circuit; a field programmable gate array (FPGA); a processor (shared, dedicated, or group) that executes code; memory (shared, dedicated, or group) that stores code executed by a processor; other suitable hardware components that provide the described functionality; or a combination of some or all of the above, such as in a system-on-chip.

The term “code,” as used above, may include software, firmware, and/or microcode, and may refer to programs, routines, functions, classes, and/or objects. The term “shared processor” encompasses a single processor that executes some or all code from multiple modules. The term “group processor” encompasses a processor that, in combination with additional processors, executes some or all code from one or more modules. The term “shared memory” encompasses a single memory that stores some or all code from multiple modules. The term “group memory” encompasses a memory that, in combination with additional memories, stores some or all code from one or more modules. The term “memory” may be a subset of the term “computer-readable medium.” The term “computer-readable medium” does not encompass transitory electrical and electromagnetic signals propagating through a medium, and may therefore be considered tangible and non-transitory memory. Non-limiting examples of a non-transitory memory include a tangible computer readable medium including a nonvolatile memory, magnetic storage, and optical storage.

The apparatuses and methods described in this application may be partially or fully implemented by one or more computer programs executed by one or more processors. The computer programs include processor-executable instructions that are stored on at least one non-transitory tangible computer readable medium. The computer programs may also include and/or rely on stored data.

A software application (i.e., a software resource) may refer to computer software that causes a computing device to perform a task. In some examples, a software application may be referred to as an “application,” an “app,” or a “program.” Example applications include, but are not limited to, system diagnostic applications, system management applications, system maintenance applications, word processing applications, spreadsheet applications, messaging applications, media streaming applications, social networking applications, and gaming applications.

The non-transitory memory may be physical devices used to store programs (e.g., sequences of instructions) or data (e.g., program state information) on a temporary or permanent basis for use by a computing device. The non-transitory memory may be volatile and/or non-volatile addressable semiconductor memory. Examples of non-volatile memory include, but are not limited to, flash memory and read-only memory (ROM)/programmable read-only memory (PROM)/erasable programmable read-only memory (EPROM)/electronically erasable programmable read-only memory (EEPROM) (e.g., typically used for firmware, such as boot programs). Examples of volatile memory include, but are not limited to, random access memory (RAM), dynamic random access memory (DRAM), static random access memory (SRAM), phase change memory (PCM) as well as disks or tapes.

These computer programs (also known as programs, software, software applications or code) include machine instructions for a programmable processor, and can be implemented in a high-level procedural and/or object-oriented programming language, and/or in assembly/machine language. As used herein, the terms “machine-readable medium” and “computer-readable medium” refer to any computer program product, non-transitory computer readable medium, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

Various implementations of the systems and techniques described herein can be realized in digital electronic and/or optical circuitry, integrated circuitry, specially designed ASICS (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

The processes and logic flows described in this specification can be performed by one or more programmable processors, also referred to as data processing hardware, executing one or more computer programs to perform functions by operating on input data and generating output. The processes and logic flows can also be performed by special purpose logic circuitry, e.g., an FPGA (field programmable gate array) or an ASIC (application specific integrated circuit). Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Computer readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

To provide for interaction with a user, one or more aspects of the disclosure can be implemented on a computer having a display device, e.g., a CRT (cathode ray tube), LCD (liquid crystal display) monitor, or touch screen for displaying information to the user and optionally a keyboard and a pointing device, e.g., a mouse or a trackball, by which the user can provide input to the computer. Other kinds of devices can be used to provide interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

In the event of a thermal runaway scenario, more than one battery cell and sometimes, more than one battery module, are affected. Absent a thermal runaway propagation (TRP) management system, system failure and/or costly damage to a vehicle is possible. Existing TRP management systems can be costly and take up a significant amount of space within the vehicle. Accordingly, these shortcomings, among others, are addressed by principles of the present disclosure.

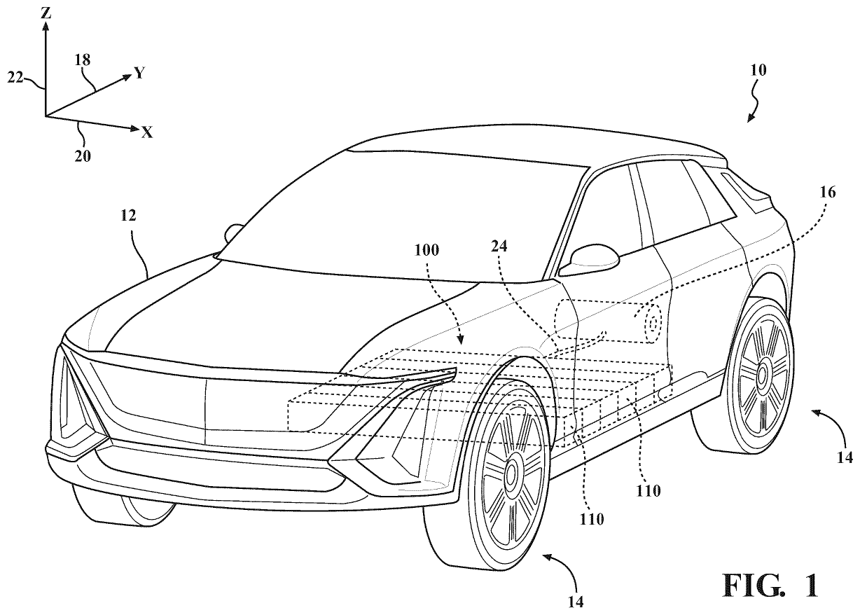

With reference to FIG. 1, a vehicle 10, such as an electric motor vehicle, is provided. The vehicle 10, includes a vehicle body 12, one or more wheels 14, and an electric motor 16 arranged in and/or coupled to the vehicle body 12. The vehicle body 12 extends along a first or longitudinal axis (i.e., fore-aft direction) 18, a second or lateral axis (i.e., cross-car direction) 20, and a third or vertical axis 22. The electric motor 16 can be configured to drive one or more of the one or more wheels 14 to propel the vehicle 10. The vehicle 10 includes a battery pack 100 that can be arranged in and/or coupled to the vehicle body 12 and is communicatively coupled to the electric motor 16 via an electric power cable 24.

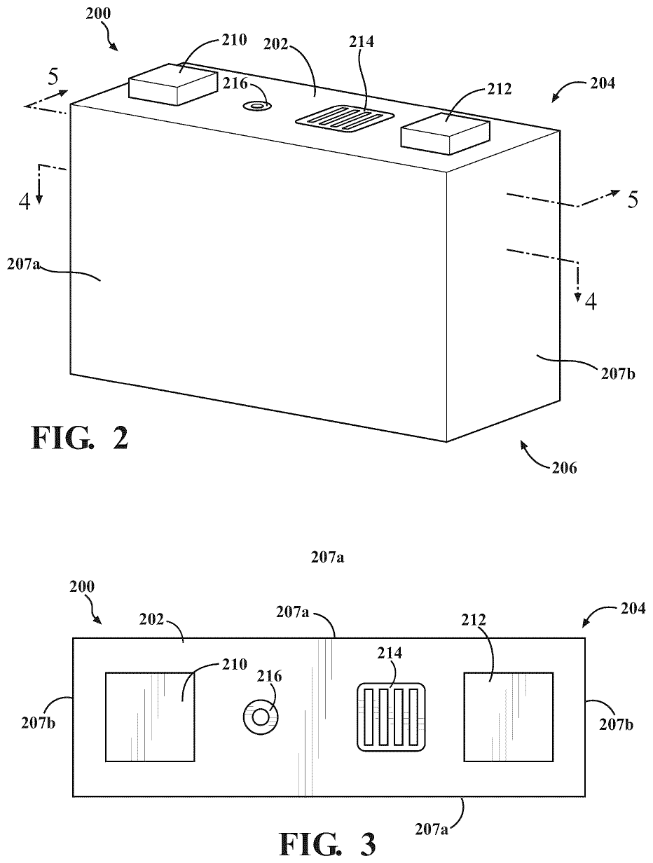

The battery pack 100 can have one or more modules 110 that include one or more prismatic battery cells 200 (FIG. 2). With reference to FIG. 2, an illustrative example of one of the one or more prismatic battery cells 200 is provided. The prismatic battery cells 200 can each include a prismatic can 202 having a first or upper end 204 and a second or lower end 206 spaced from the upper end 204. The prismatic can 202 includes one or more side walls 207a and one or more end walls 207b that each extend between the first end 204 and the second end 206. The one or more side walls 207a and the one or more end walls 207b define a chamber 208 (FIG. 5) that extends between the first end 204 and the second end 206.

With reference to FIGS. 2 and 3, a first terminal 210 and a second terminal 212 can be coupled to and/or arranged on the prismatic can 202 at the upper end 204. Additionally, with reference to FIGS. 3 and 5, a vent 214 can be coupled to and/or or arranged on the prismatic can 202 and is in fluid communication with the chamber 208 to regulate pressure within the chamber 208, for example. The prismatic battery cell 200 can also include a fill port 216, such as a quick release fill port, coupled to and/or arranged on the prismatic can 202. The prismatic battery cell 200 can further include a thermal conductive pathway 218 at the lower end 206 of the prismatic can 202 that extends between the one or more end walls 207b and one or more side walls 207a (FIG. 3), as shown in FIG. 5. The thermal conductive pathway 218 can include a cooling plate or cooling pathway and may desirable for removing heat from the prismatic battery cells 200.

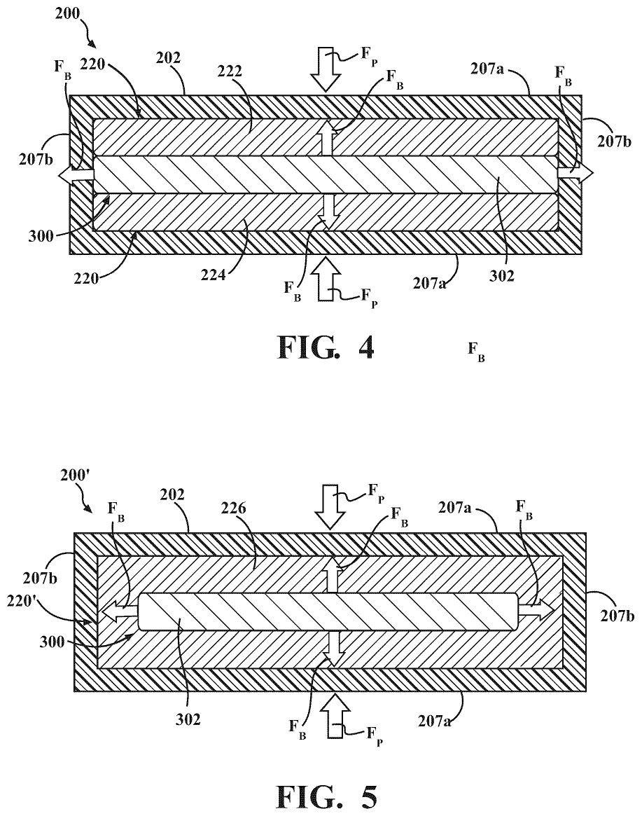

With reference to FIGS. 4 and 5, battery internals, such as one or more jelly rolls 220, 220′, can be arranged in the chamber 208 of the prismatic can 202. In one configuration, as shown in FIG. 4, the one or more jelly rolls 220 can include a first jelly roll 222 and a second jelly roll 224 spaced from the first jelly roll 222 (i.e., a stacked jelly roll design). In another configuration, as shown in FIG. 5, the one or more jelly rolls 220′ includes a wound jelly roll 226 arranged in the prismatic can 202 of the prismatic battery cell 200′.

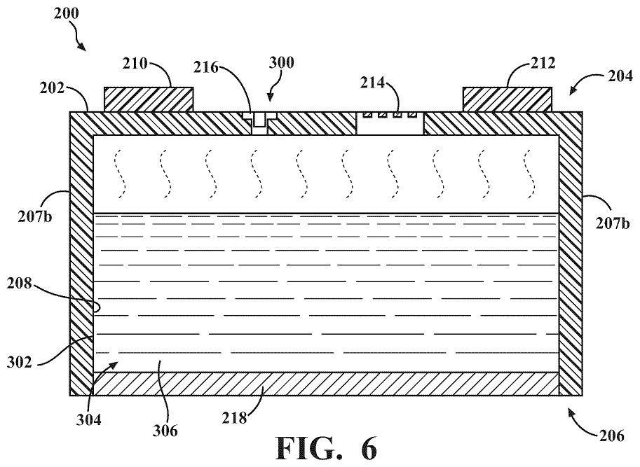

With continued reference to FIGS. 4, 5, and 6, the prismatic battery cells 200, 200′ can further include a thermal runaway propagation (TRP) management system 300. The TRP management system 300 can include a bladder 302 arranged in the chamber 208 that extends between the upper end 204 and the lower end 206 of the prismatic can 202. The bladder 302 defines a bladder volume 304 that is communicatively coupled to the fill port 216. A fluid 306 can be added and/or removed from the bladder 302 via the fill port 216. According to one aspect, the fluid 306 can include a non-combustible fluid with a heat of vaporization that can boil and absorb energy from the prismatic battery cell 200 during a thermal runaway scenario. For instance, the fluid 306 can include a sodium bicarbonate slurry that, at a temperature equal to or greater than 80° C., releases solid sodium carbonate, water, and carbon dioxide. During normal operation, the fluid 306 can consume about a quarter to half of the bladder volume 304. According to one aspect, the prismatic battery cell 200 can further include an active fluid system (not shown) coupled to the fill port 216 and continuously maintains and/or adjusts a bladder pressure of the bladder 302 by adding and/or removing fluid from the bladder 302 during normal operation. During cell assembly, the fluid 306 can consume about all or most of the bladder volume 304 and build up a bladder pressure that exerts an outward force F_{B} (FIGS. 4 and 5) toward the one or more jelly rolls 220, 220′ and/or the prismatic can 202, for example.

According to one aspect, during assembly, the prismatic battery cell 200 can undergo a mechanical pre-treatment process (i.e., a formation procedure) to aid with formation of one or more protective layers (i.e., solid electrolyte interphase (SEI) or cathode electrolyte interphase (CEI)) on electrodes (i.e., anodes and/or cathodes) of the battery internals. In general, mechanical pre-treatment processing includes applying a mechanical force F_{P} on an outer surface of the prismatic can 202 (FIGS. 4 and 5). Here, however, the outward force F_{B} generated by the bladder pressure can oppose the mechanical force F_{P} applied to the one or more side walls 207a and/or the one or more end walls 207b of the prismatic can 202 so that a uniform force acts on the battery internals (i.e., the one or more jelly rolls 220, 220′), for example. According to one aspect, the uniform force may be desirable to improve formation of the protective layers on the electrodes.

With reference to FIGS. 4 and 5, the bladder 302 can be arranged with respect to the one or more jelly rolls 220, 220′. According to one aspect, as shown in FIG. 4, the bladder 302 can be sandwiched between the first jelly roll 222 and the second jelly roll 224. According to another aspect, as shown in FIG. 5, the wound jelly roll 226 can be arranged about a perimeter the bladder 302. The bladder 302 can be made of a polyethylene terephthalate, steel, aluminum, or an aluminum alloy, for example. It may be desirable for the bladder 302 to be made of steel so that there is no mixture of the fluid 306 and the cell internals, such as an electrolyte of the one or more jelly rolls 320, during a thermal runaway scenario. On the other hand, it may be desirable for the bladder 302 to be made of aluminum so that the bladder 302 can melt during a thermal runaway scenario and the fluid 306 can quench the cell internals, such as the one or more jelly rolls 220, 220′.

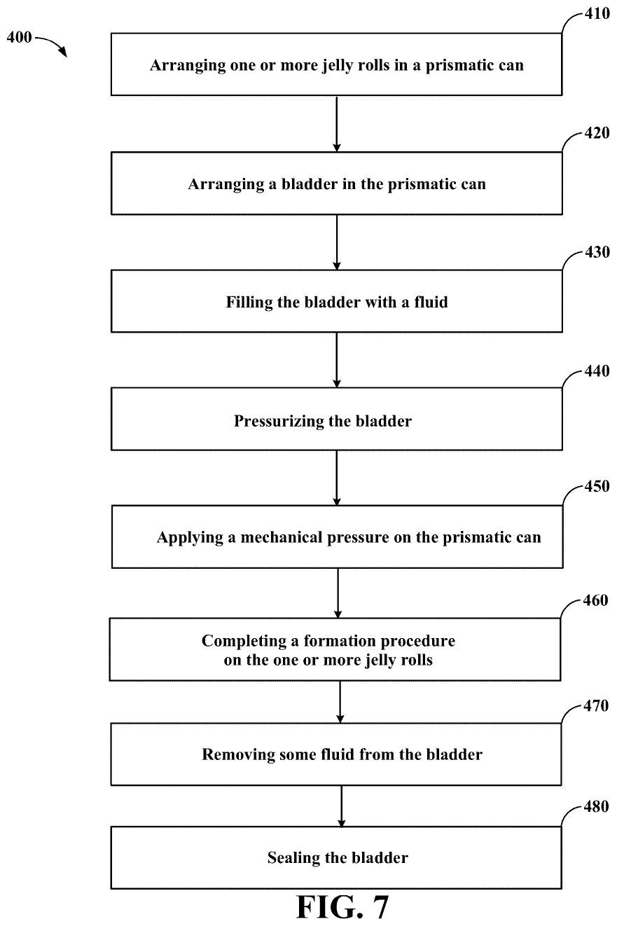

With reference to FIG. 7, a method 400 of manufacturing the prismatic battery cell 200 is provided. At 410, the one or more jelly rolls 220 can be arranged in the prismatic can 202 of one of the prismatic battery cells 200.

At 420, the bladder 302 can be arranged in the prismatic can 202 with respect to the one or more jelly rolls 220. As introduced above, the bladder 302 can be stacked between the first jelly roll 222 and the second jelly roll 224 or the wound jelly roll 226 can be arranged about the perimeter of the bladder 302, for example.

At 430, the bladder 302 can be filled with the fluid 306 via the fill port 216.

At 440, the bladder 302 can pressurized to establish the bladder pressure that exerts the bladder force F_{B} (FIGS. 4 and 5) on the one or more jelly rolls 220 and/or the prismatic can 202.

At 450, the mechanical force F_{P} can be applied on the prismatic can 202 that acts opposite the bladder force F_{B} established by bladder pressure.

At 460, a formation procedure can be carried out for developing one or more protective layers (i.e., solid electrolyte interphase (SEI)) on electrodes of the one or more jelly rolls.

At 470, some of the fluid 306 can be removed from the bladder 302 via the fill port 216. As indicated above, the fluid 306 may consume about half of the bladder 302 during normal operation of the prismatic battery cell 200.

At 480, the bladder 302 can be sealed so that it is configured to operate as the TRP management system 300.

A number of implementations have been described. Nevertheless, it will be understood that various modifications may be made without departing from the spirit and scope of the disclosure. Accordingly, other implementations are within the scope of the following claims.

The foregoing description has been provided for purposes of illustration and description. It is not intended to be exhaustive or to limit the disclosure. Individual elements or features of a particular configuration are generally not limited to that particular configuration, but, where applicable, are interchangeable and can be used in a selected configuration, even if not specifically shown or described. The same may also be varied in many ways. Such variations are not to be regarded as a departure from the disclosure, and all such modifications are intended to be included within the scope of the disclosure.

What is claimed is:

1. A prismatic battery cell, comprising:
a prismatic can defining a chamber;
a first terminal and a second terminal each coupled to the prismatic can;
a vent coupled to the prismatic can and in fluid communication with the chamber;
battery internals arranged in the chamber comprising at least one jelly roll; and
a thermal runaway propagation management (TRP) system comprising:
a bladder arranged in the chamber with respect to the at least one jelly roll,
a port coupled to the prismatic can and in fluid communication with the bladder, and
a fluid at least partially filling the bladder.

2. The prismatic battery cell of claim 1, wherein the prismatic can includes a first end and a second end opposite the first end.

3. The prismatic battery cell of claim 2, wherein the chamber further includes a thermal conductive pathway at the second end for removing heat from the prismatic battery cell.

4. The prismatic battery cell of claim 3, wherein the bladder extends between the first end and the second end and contacts the thermal conductive pathway.

5. The prismatic battery cell of claim 1, wherein the bladder defines a bladder volume and the fluid consumes about half of the bladder volume during normal operation of the prismatic battery cell.

6. The prismatic battery cell of claim 1, wherein the bladder defines a bladder volume and the fluid consumes about all of the bladder volume during cell assembly.

7. The prismatic battery cell of claim 1, wherein the fluid has a low boiling point.

8. The prismatic battery cell of claim 7, wherein the fluid is a sodium bicarbonate slurry.

9. The prismatic battery cell of claim 1, wherein the bladder is made of an aluminum alloy.

10. The prismatic battery cell of claim 1, wherein the bladder is made of polyethylene terephthalate.

11. The prismatic battery cell of claim 1, wherein the at least one jelly roll includes a first jelly roll and a second jelly roll, the bladder being sandwiched between the first jelly roll and the second jelly roll.

12. The prismatic battery cell of claim 1, wherein the at least one jelly roll is wound around the bladder.

13. A vehicle, comprising:
a vehicle body;
a battery pack including one or more battery modules and coupled to the vehicle body; and
one or more prismatic battery cells arranged in the one or more battery modules, comprising:
a prismatic can defining a chamber;
a first terminal and a second terminal each coupled to the prismatic can;
a vent coupled to the prismatic can in fluid communication with the chamber;
battery internals arranged in the chamber comprising at least one jelly roll; and
a thermal runaway propagation (TRP) management system comprising:
a bladder defining a bladder volume and arranged in the chamber with respect to the at least one jelly roll,
a port coupled to the prismatic can and in fluid communication with the bladder, and
a fluid comprising a low boiling point at least partially filling the bladder during normal cell operation.

14. The vehicle of claim 13, wherein the chamber further includes a thermal conductive pathway for removing heat from the prismatic can.

15. The vehicle of claim 13, wherein the fluid is a sodium bicarbonate slurry.

16. The vehicle of claim 13, wherein the bladder is made of an aluminum alloy.

17. The vehicle of claim 13, wherein the bladder is made of polyethylene terephthalate.

18. The vehicle of claim 13, wherein the at least one jelly roll includes a first jelly roll and a second jelly roll, the bladder being sandwiched between the first jelly roll and the second jelly roll.

19. The vehicle of claim 13, wherein the at least one jelly roll is wound around the bladder.

20. A method of manufacturing a prismatic battery cell, comprising:
arranging one or more jelly rolls in a prismatic can;
arranging a bladder in the prismatic can with respect to the one or more jelly rolls;
filling the bladder with a fluid via a fill port;
pressurizing the bladder so that the bladder exerts a bladder force on the one or more jelly rolls and the prismatic can;
applying a mechanical force on the prismatic can opposite the bladder force;
completing a formation procedure for developing one or more protective layers on electrodes of the one or more jelly rolls;
removing at least some of the fluid from the bladder via the fill port; and
sealing the bladder so that the bladder is configured to operate as a thermal runaway propagation (TRP) management system.
